(19) United States
(12) Patent Application Publication
(10) Pub. No.: US 2026/0197429 A1
(43) Pub. Date: Jul. 9, 2026

(54) MULTIPLE PAIRS OF CAMERAS FOR STEREOSCOPY

(71) Applicant: X-Biomedical, Inc., Bryn Mawr, PA (US)

(72) Inventors: Matthew R. Maltese, Wallingford, PA (US); Mario Mischewski, Marthod (FR)

(73) Assignee: X-Biomedical, Inc., Bryn Mawr, PA (US)

(21) Appl. No.: 19/408,730

(22) Filed: Dec. 4, 2025

Related U.S. Application Data
(60) Provisional application No. 63/727,969, filed on Dec. 4, 2024.

(51) Int. Cl. H04N 13/139; G02B 21/00; G02B 21/22; G02B 21/36; H04N 13/122; H04N 13/243; H04N 13/254; H04N 13/344

(52) U.S. Cl. CPC H04N 13/139; G02B 21/0012; G02B 21/22; G02B 21/365; H04N 13/122; H04N 13/243; H04N 13/254; H04N 13/344

(57) ABSTRACT

A stereoscopic digital surgical visualization system uses multiple fixed-lens camera pairs. A scope head includes a plurality of stereoscopic camera pairs, each pair having fixed lenses and corresponding image sensors configured to capture left-eye and right-eye image data at different magnification levels without mechanical zoom components. A processing unit receives the stereoscopic image data, digitally crops and scales the imagery to generate digitally magnified stereoscopic views, and automatically transitions between camera pairs to form a continuous stereoscopic magnification sequence. A smartglasses display with left-eye and right-eye OLED micro-projectors presents the stereoscopic imagery in real time. In some embodiments, the system provides stereoscopic alignment correction, augmented-reality overlays, integrated LED illumination, impact-resistant construction, battery-powered operation, and real-time recording or streaming of stereoscopic video.

### TECHNICAL FIELD

The present disclosure relates generally to surgical visualization systems and, more particularly, to stereoscopic digital surgical microscopes and magnification systems suitable for use in both pristine and austere medical environments.

### BACKGROUND

Surgical microscopes are essential tools in ophthalmic surgery, microsurgery, dental procedures, and numerous clinical specialties that require magnification and stereoscopic visualization of a surgical field. Existing surgical microscopes generally fall into two categories: light-transmission microscopes and digital microscope systems (also referred to as exoscopes).

Light-transmission microscopes typically rely on complex optical assemblies—lenses, mirrors, prisms, beam splitters, and oculars—to create a magnified stereoscopic image. As illustrated in FIG. 2(i), such systems require the surgeon to maintain contact with the oculars for prolonged periods, which may contribute to ergonomic strain during long procedures. Digital microscope systems, also shown in FIG. 2(ii), use CMOS imaging sensors and motor-and-gear driven lenses to capture the surgical field and display the resulting stereoscopic image on one or more external 3D monitors. While these systems eliminate the need for oculars, they depend on large, fragile display units and occupy significant space in an operating room.

Both categories of microscopes share significant limitations. These systems are typically large, heavy, and mechanically fragile, with many weighing several hundred kilograms. Their complex internal components, including motorized zoom assemblies, render them difficult to transport, set up, calibrate, and maintain. Transport through rural regions, low-income countries, humanitarian missions, or combat medical settings can result in mechanical damage or misalignment, often rendering the system inoperable. The challenges posed by weight, fragility, and mechanical complexity limit the availability of functional surgical microscopes to pristine medical environments.

Global health disparities further highlight these shortcomings. As illustrated in FIG. 1, the incidence of pediatric blindness—including conditions such as congenital cataract and traumatic ocular injury—is significantly higher in low-income regions. Many of these conditions require early surgical intervention under magnification; however, delays in treatment are common due to the scarcity or dysfunction of surgical microscopes suitable for those environments. Similar limitations exist in battlefield medicine, where ocular injuries remain frequent while available visualization equipment is inadequate for field deployment.

Efforts have been made to reduce reliance on large optical assemblies. For example, FIG. 3 depicts a prior digital system that uses a single pair of stereoscopic cameras mounted within a microscope scopehead, transmitting imagery to smartglasses worn by the clinician. As depicted, a microscope scopehead 302 with a two-camera system has a left camera 304 with a conventional zoom and a right camera 306 with a conventional zoom, and smartglasses 308 worn by a user 310. The user 310 may be a doctor or a technician. While such systems reduce dependence on bulky 3D monitors, they continue to rely on motor-and-gear-driven zoom-lens mechanisms within the camera modules. As shown in FIG. 4, these motor-and-gear assemblies contain delicate components, including gear trains 402, motorized actuators 404, and movable lens carriers 406, that are highly susceptible to impact or vibration damage. As a result, even modern digital microscopes remain unsuitable for rugged medical use.

Outside the surgical domain, multi-camera smartphone architectures demonstrate fixed-lens magnification concepts. FIG. 5 illustrates an example of a mobile device equipped with multiple single-camera modules, such as a wide-angle camera 502, an ultra-wide camera 504, and a telephoto lens 506, each having a unique focal length. The wide-angle camera 502 is a standard, all-purpose lens for everyday shots, and the ultra wide-angle camera 504 is designed to capture a much wider field of view, making it ideal for landscapes, group photos, and architectural shots. Further, the telephoto lens 506 provides optical zoom, which allows a user to get closer to a subject without moving their feet or sacrificing image quality. Smartphone systems use crop-and-scale digital zoom combined with automatic switching between cameras to cover wide magnification ranges. However, such systems produce only monocular images and are not capable of stereoscopic visualization or the depth perception required for microsurgical tasks.

There remains a need for a portable, durable, digital magnification system that can operate reliably in both controlled surgical settings and austere environments. Such a system should eliminate reliance on fragile, popular zoom optics, provide user-controlled direct vision, maintain precise alignment between subject images, and withstand handling, scalability, transportation, and impact conditions encountered inside and outside traditional surgical facilities.

### SUMMARY

The following summarizes some embodiments of the present disclosure to provide a basic understanding of various aspects of the disclosure. This summary is not an extensive overview of the present disclosure. It is not intended to identify critical elements of the present disclosure or to delineate the scope of the present disclosure. Its sole purpose is to present some embodiments of the present disclosure in a simplified form as a prelude to the more detailed description that is presented below.

The present disclosure relates to stereoscopic digital surgical microscopy systems, apparatuses, and methods. In various embodiments, a stereoscopic digital surgical microscope system is provided that includes a scope head having a plurality of fixed-lens stereoscopic camera pairs. Each camera pair may include two fixed lenses and corresponding image sensors configured to capture left-eye and right-eye stereoscopic image data at a predefined or user-or system-specified magnification level. The plurality of camera pairs may be arranged such that the system captures stereoscopic image data across multiple magnification levels without requiring mechanical movement of optical elements.

In certain embodiments, a processing unit is configured to receive stereoscopic image data from the plurality of fixed-lens camera pairs and to generate digitally magnified stereoscopic imagery. The processing unit may digitally crop and scale the stereoscopic image data, and may automatically transition between the camera pairs based on a user-selected or system-determined magnification.

The processing unit may further control the selection of camera pairs in accordance with the magnification request to generate a stereoscopic magnification sequence comprising a series of digitally magnified stereoscopic images at different magnification levels.

A smartglasses display may include left-eye and right-eye OLED micro-projectors. The smartglasses display may receive the stereoscopic magnification sequence and present corresponding left-eye and right-eye imagery to a user in real time.

In certain embodiments, the digitally magnified stereoscopic imagery may be merged or assembled by the processing unit to form a stereoscopic video stream. The stereoscopic video stream may be delivered directly to the smartglasses display, recorded while being transmitted for real-time viewing, or processed for distribution to external computing devices.

In some embodiments, the stereoscopic video stream may include alignment information generated during transitions between camera pairs. The alignment information may be used to maintain stereoscopic depth and camera-to-surgical field consistency when the system transitions across magnification levels. The processing unit may further include software configured to digitally shift at least one stereoscopic image, image frame, or image stream to compensate for misalignment resulting from optical tolerances, sensor variations, camera-pair switching, or differences in focal positions. Such shifting may occur before or during projection of the stereoscopic imagery to the smartglasses display.

The scope head may, in some embodiments, be constructed to withstand mechanical impacts, including an impact drop from a defined height, without loss of stereoscopic image capture functionality. The system may also include an integrated illumination module comprising one or more light sources arranged around the plurality of camera pairs to illuminate a surgical field during image capture. A rechargeable battery system may be included to provide power to the scope head and the processing unit for portable operation.

In certain embodiments, the processing unit may superimpose augmented-reality (AR) surgical guidance information within the stereoscopic imagery. The superimposed AR data may include markings, overlays, annotations, or visual indicators derived from external computing sources or integrated software modules. The processing unit may further be configured to record stereoscopic imagery and stream it in real time to one or more external displays, networks, or computing devices.

Another aspect of the disclosure provides a digital zoom stereoscopic visualization apparatus. The apparatus may include a plurality of stereoscopic camera pairs, each having fixed lenses of differing focal lengths and dual CMOS image sensors configured to capture image streams subsequently project to the left-eye and right-eye data. A processor may digitally crop and scale image data from at least one stereoscopic camera pair to generate digitally magnified stereoscopic imagery across a continuous magnification range, and a smartglasses display may be configured to present the left-eye and right-eye imagery to a user.

A further aspect of the disclosure provides methods for stereoscopic digital surgical visualization. In certain implementations, the method includes capturing stereoscopic image data using a plurality of fixed-lens stereoscopic camera pairs, receiving the stereoscopic image data at a processing unit, digitally cropping and scaling the stereoscopic image data to generate digitally magnified stereoscopic imagery, and generating a stereoscopic magnification sequence.

The method may further include automatically transitioning between the camera pairs based on a user-selected magnification, and presenting the stereoscopic magnification sequence on a smartglasses display in real time.

Additional operations may include generating a stereoscopic video stream, producing alignment information for transitions between magnification levels, digitally shifting stereoscopic image data to compensate for misalignment, providing illumination using integrated LED arrays, presenting augmented-reality overlays within the stereoscopic imagery, and recording or streaming the stereoscopic imagery to external devices.

### BRIEF DESCRIPTION OF THE FIGURES

Further advantages of the present disclosure will become apparent by reference to the detailed description of preferred embodiments when considered in conjunction with the drawings.

FIG. 1 illustrates an example of blindness encountered in austere medical environments, including a traumatic globe rupture.

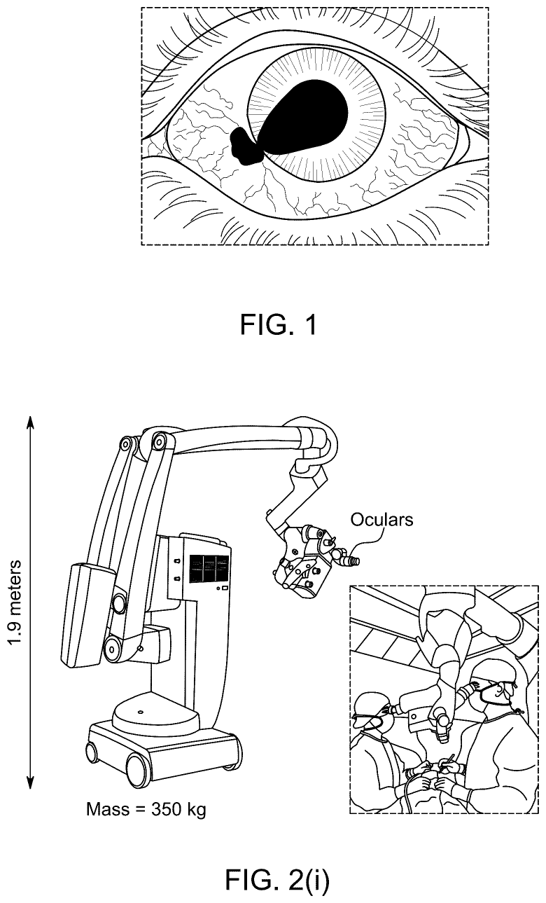

FIG. 2 shows representative examples of state-of-the-art conventional surgical microscopes, including a light-transmission microscope (2(i)) and a digital microscope system (2(ii)).

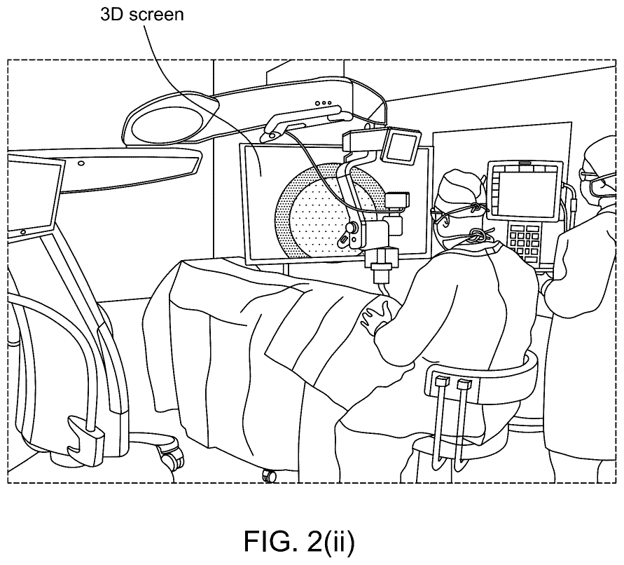

FIG. 3 depicts a previously developed digital surgical microscope incorporating a single stereoscopic camera pair and smartglasses.

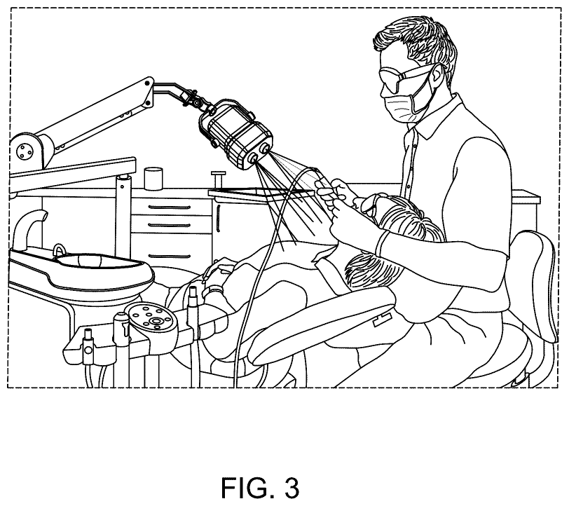

FIG. 4 illustrates an example of a motor-and-gear drive system used in zoom lenses of conventional digital microscope systems.

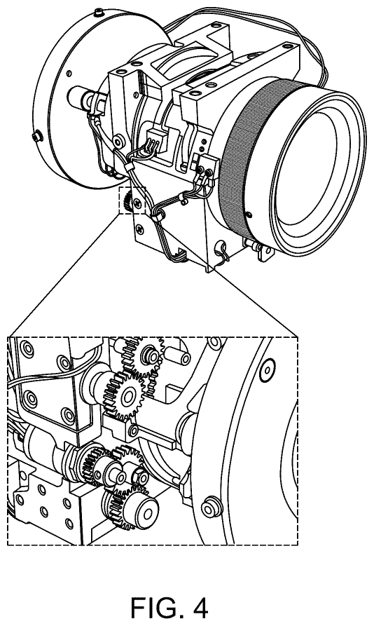

FIG. 5 shows a conventional smartphone multi-camera arrangement employing multiple fixed-lens cameras with different focal lengths to achieve digital magnification.

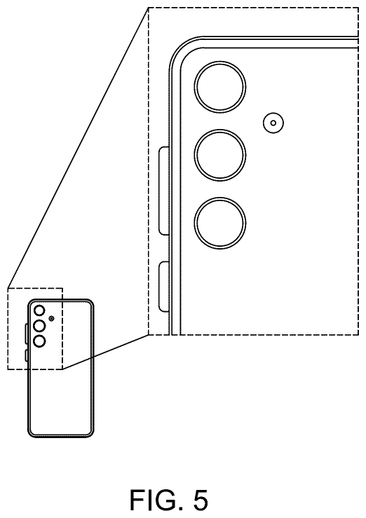

FIG. 6 illustrates an exemplary system-level architecture of a stereoscopic digital surgical microscope system, according to an embodiment of the present disclosure.

FIG. 7 depicts an exemplary multi-camera scopehead configuration for a stereoscopic fixed-lens magnification system, according to an embodiment.

FIG. 8 illustrates a camera-alignment system used in a two-camera stereoscopic microscope, according to an embodiment.

FIG. 9 shows an example high-resolution image captured using a CMOS/lens system, according to an embodiment.

FIG. 10 illustrates a latency-measurement setup employing an image-capture camera directed at a reference clock and a corresponding OLED display image, according to an embodiment.

FIG. 11 illustrates an exemplary method for performing stereoscopic digital surgical visualization using multiple fixed-lens camera pairs, according to an embodiment.

### DETAILED DESCRIPTION

The following detailed description is presented to enable a person skilled in the art to make and use the systems and methods of the present disclosure. For purposes of explanation, specific details are set forth to provide an understanding of the present disclosure. However, it will be apparent to one skilled in the art that these specific details are not required to practice the embodiments of the present disclosure. Descriptions of specific applications are provided only as representative examples. Various modifications to the embodiments described herein will be apparent to one skilled in the art, and the general principles defined herein may be applied to other embodiments and applications without departing from the scope of the present disclosure. The present disclosure is not intended to be limited to the embodiments shown but is to be accorded the widest possible scope consistent with the principles and features disclosed herein.

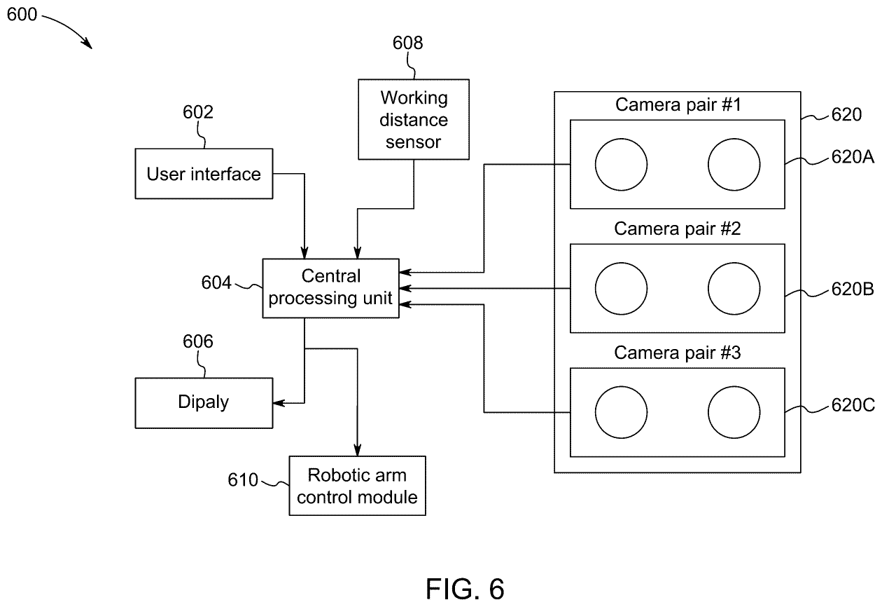

FIG. 6 illustrates an exemplary system-level architecture 600 of a stereoscopic digital surgical microscope system configured to provide digitally magnified stereoscopic visualization through a plurality of fixed-lens camera pairs. In various embodiments, the system 600 comprises a user interface 602, a scope head 620 containing multiple fixed-lens stereoscopic camera pairs 620A, 620B, and 620C, a central processing unit (CPU) 604, an optional robotic arm control module 610, a working-distance sensor 608, and a smartglasses display system 606 having left-eye and right-eye OLED micro-projectors.

In contrast to conventional digital microscopes that rely on motor-and-gear-driven zoom mechanisms, the system described herein uses a plurality of fixed-lens camera pairs and digital magnification techniques. As a result, the system is free of mechanically fragile zoom assemblies and can deliver stereoscopic magnification through crop-and-scale processing and automatic camera-pair selection.

In the embodiment shown in FIG. 6, the user interface 602 enables a surgeon or operator to select a desired zoom level, a user-selected magnification, a working mode, or a display configuration. The user interface may take any suitable form, including a touch-sensitive tablet or display, a keyboard or keypad, a foot pedal, a joystick or tactile controller, or a voice-recognition system configured to interpret spoken commands.

Upon receiving the user's Zoom request, the user interface communicates the user-selected magnification value to the CPU 604, which governs subsequent system-level operations.

The scope head 620 houses a plurality of fixed-lens stereoscopic camera pairs 620A, 620B, and 620C, each pair configured to capture left-eye and right-eye stereoscopic image data at a corresponding magnification level. In exemplary embodiments, a first camera pair provides low magnification (e.g., 2×-4×), a second camera pair provides intermediate magnification (e.g., 5×-12×), and a third camera pair provides high magnification (e.g., 13×-20×).

Each camera pair comprises two fixed-lens cameras mounted at predetermined spacing and orientation to achieve stereoscopic depth perception. Because each camera pair uses a fixed optical configuration, the system is inherently free of motorized zoom lens assemblies, enhancing durability, ruggedness, and portability. Upon receiving the magnification input from the user interface, the CPU 604 determines which camera pair is best suited to generate imagery corresponding to the requested zoom value. The CPU 604 activates one camera pair while deactivating others. If the user-requested magnification lies within the optical range of a particular pair, the CPU selects that pair as the active imaging source.

The CPU 604 receives the raw stereoscopic image data from the active camera pair and applies digital magnification through cropping—reducing the number of active pixels within a central region of each left-eye and right-eye image; and scaling—enlarging the cropped stereoscopic region to match the output display resolution. This crop-and-scale approach simulates optical zoom without requiring mechanical lens movement.

When the digital zoom reaches the upper or lower limit of a given camera pair's effective range, the CPU 604 automatically transitions to the next appropriate camera pair. During this transition, the CPU 604 generates alignment information to preserve stereoscopic depth fidelity, such as lateral pixel-shift corrections, toe-in or angular adjustments, inter-camera disparity compensation, or geometric remapping of the stereoscopic image pair. The CPU 604 may perform such adjustments in real time to prevent stereoscopic misalignment, double vision, or visual discomfort.

By combining the digitally magnified left-eye and right-eye streams and applying real-time alignment controls, the CPU 604 generates a stereoscopic video stream representing a continuous magnification sequence. In some embodiments, the stereoscopic video stream is delivered directly to the smartglasses display; the stream is recorded simultaneously for training or documentation; or the stream is encoded for live telemedicine, telepresence, or remote collaboration. The system may also embed alignment metadata within the stereoscopic video stream to maintain depth fidelity throughout magnification changes.

The smartglasses display 612 includes left-eye and right-eye OLED micro-projectors configured to present the stereoscopic magnification sequence directly to the user's eyes in real time. The display system provides stereoscopic depth cues, high-resolution imagery, and low-latency responsiveness, making it suitable for microsurgical tasks.

In alternative embodiments, the stereoscopic output may instead be delivered to a head-mounted binocular display, a stereoscopic 3D television, or conventional microscope oculars adapted to accept stereo digital input.

In some embodiments, the system includes a robotic arm control module 608 that positions a robotic arm to hold or position the scope head above the surgical field. The CPU 604 may instruct the robotic arm to reposition the scope head to optimize the field of view, track user commands or automated movement patterns, or adjust to anatomical changes or surgeon hand motions.

A working-distance sensor 608 may be incorporated to monitor the distance between the scope head and the surgical site. The CPU may use this information to maintain optimal focusing geometry, modify digital magnification parameters, and apply alignment corrections based on depth changes.

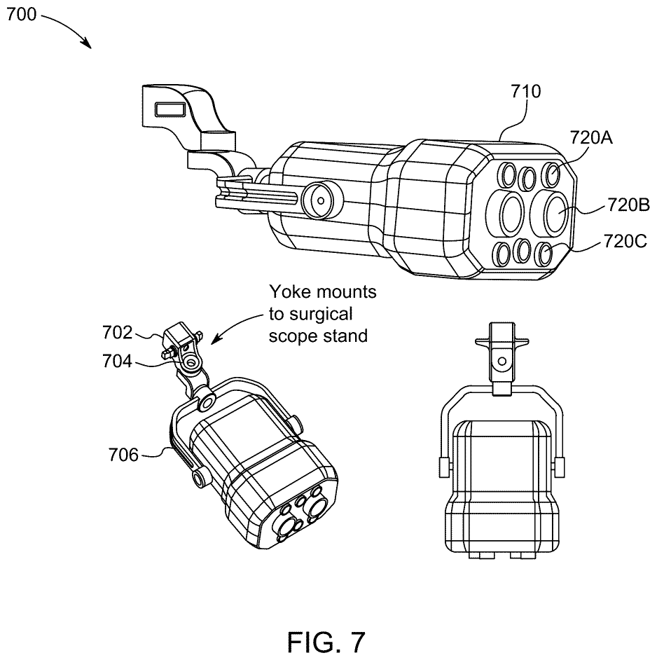

FIG. 7 illustrates an exemplary embodiment of a multi-camera scopehead configuration 700 for a stereoscopic fixed-lens magnification system (“Ocelli-α”), according to an embodiment of the present disclosure. The scopehead 710 includes a plurality of fixed-lens stereoscopic camera pairs 720A, 720B, 720C, each camera pair configured to capture stereoscopic imagery at a corresponding optical magnification level. The plurality of camera pairs 720A, 720B, 720C may be arranged to collectively span a magnification range from approximately 1× to 40× without requiring mechanical actuation of the lens.

Each camera pair, 720A, 720B, 720C, includes two fixed-lens cameras positioned at a calibrated inter-axial spacing to support stereoscopic depth perception. In certain embodiments, each camera comprises a CMOS sensor with a resolution of at least 20 megapixels, enabling high-resolution images suitable for digital crop-and-scale magnification. The use of fixed lenses eliminates reliance on motor-and-gear-driven zoom mechanisms and enhances durability, shock resistance, and optical stability across magnification levels.

In some embodiments, the scopehead 710 is enclosed within a ruggedized housing that protects the camera pairs from shock, vibration, impact, and environmental stresses. The housing may include polymer-based or composite shock-absorbing materials, elastomeric suspension mounts around each camera module, rigid internal support structures to prevent optical misalignment, and reinforced external ribs for structural stability.

In at least one embodiment, the scopehead is configured to withstand an impact drop from approximately 36 inches onto a rigid surface, in multiple orientations, without loss of stereoscopic functionality. Following impact, the camera pairs maintain optical alignment and stereoscopic convergence, allowing uninterrupted operation in austere medical environments.

In various embodiments, the scopehead 710 includes an illumination module comprising one or more LED lighting arrays arranged around or adjacent to the plurality of camera pairs. The LED arrays may be circumferentially arranged around the front face of the scopehead, positioned near each camera pair to provide pair-specific illumination, or embedded along the housing interior at predetermined angles. The illumination module provides uniform light distribution onto the surgical field, reduces shadowing from instruments, and maintains consistent color rendition during magnification transitions. In some embodiments, illumination intensity, beam pattern, or spectral characteristics may be dynamically adjusted by the processing unit.

The system may further include a rechargeable battery system configured to provide power to the scopehead, the processing unit, the illumination module, and auxiliary electronics. The battery system may be located within the scopehead housing, in an external battery pack mounted to a stand or belt, or distributed between the scopehead and processing unit. In some embodiments, the battery system enables 6 hours of continuous stereoscopic operation without connection to external power, thereby supporting portability in remote, rural, military, or emergency medical environments.

The plurality of fixed-lens camera pairs 720A, 720B, 720C is positioned such that each pair corresponds to a distinct magnification level. Examples include a camera pair 720A wide-field for low magnification for gross visualization, a camera pair 720B for ultra wide-field magnification for tissue-level detail, a camera pair 720C for telescopic lens or high magnification for microsurgical precision. Each camera pair provides a unique stereoscopic field of view. When combined with digital crop-and-scale magnification performed by the processing unit (described in connection with FIG. 6), the system generates a continuous stereoscopic magnification sequence across the full range. To preserve stereoscopic depth fidelity during imaging, the camera pairs may be factory-calibrated or calibrated in-field for inter-axial distance, angular toe-in orientation, vertical and horizontal alignment, and focus geometry at working-distance ranges.

In the embodiment of FIG. 7, the scopehead 710 may be coupled to a yoke assembly having a mount fix 702, middle fix 704, and a front fix 706 for a mechanical mounting structure. This assembly allows secure attachment to a surgical microscope stand, a robotic positioning arm, a portable tripod, or a ceiling-or wall-mounted support. The mounting arrangement enables stable positioning above the surgical field while permitting manual or automated repositioning. Cable interfaces or wireless links may transmit stereoscopic video streams to the processing unit.

During operation, each camera pair supplies stereoscopic video to the processing unit. As magnification requirements change, the system may activate the corresponding fixed-lens camera pair, digitally crop and scale the stereoscopic images, maintain alignment consistency between left and right channels, and generate a continuous stereoscopic output stream without requiring any mechanical movement of optical components. This fixed-lens, multi-camera architecture provides the stereoscopic performance of a surgical microscope while offering greater durability, reduced size, and enhanced portability.

In one example, the multi-camera scopehead of FIG. 7 provides the following functional characteristics multiple fixed-lens stereoscopic camera pairs covering 1×-40×magnification, CMOS sensors ≥20 MP per camera for high-resolution image capture, shock-resistant housing capable of withstanding ~36-inch impact drops without loss of stereoscopic performance, integrated LED illumination for uniform field lighting, support for rechargeable battery operation for use in low-resource settings, enhanced durability due to the absence of motorized zoom mechanisms, compatibility with digital zoom and CPU-driven stereoscopic alignment for seamless magnification transitions, mounting flexibility via yoke or robotic-arm structures.

These features enable the Ocelli-α scopehead to function in both pristine surgical environments and austere field conditions while providing high-quality stereoscopic visualization across a continuous magnification range.

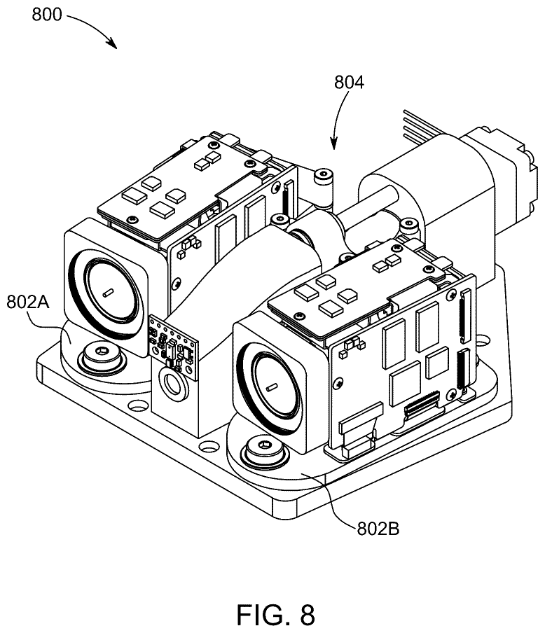

FIG. 8 illustrates an exemplary camera alignment system 800 suitable for use in a stereoscopic digital surgical microscope that employs multiple fixed-lens stereoscopic camera pairs, according to an embodiment of the present disclosure. The alignment system may initially be derived from techniques used in two-camera surgical microscope configurations; however, the embodiment shown in FIG. 8 extends such techniques to support multiple stereoscopic camera pairs, each pair having unique focal lengths, camera spacing, and angular orientation.

In the embodiment of FIG. 8, the alignment system 800 includes mechanical, optical, and software-controlled components configured to maintain proper stereoscopic convergence between the left-eye and right-eye image streams for each fixed-lens camera pair 802A, 802B. The CPU controller 804 controls the camera pair 802A and 802B. Maintaining stereoscopic alignment is essential for generating accurate three-dimensional perception during surgical visualization, as each eye receives a slightly different perspective of the surgical field and the user's brain fuses the two images into a single stereoscopic representation.

When multiple fixed-lens camera pairs are incorporated into a single scopehead—each with different focal lengths and optical geometries—the alignment system 800 ensures that stereoscopic correspondence is preserved for each pair 802A, 802B. In some embodiments, the alignment system includes toe-in adjustment mechanisms for setting angular convergence, lateral and vertical shift interfaces for precise inter-camera alignment, calibration structures that maintain consistent optical geometry during operation, and software-based correction algorithms that compensate for micro-misalignments.

During magnification transitions, the processing unit may switch from a first camera pair to a second camera pair. Because each pair has distinct optical characteristics, such transitions may introduce stereoscopic offsets. To address this, the embodiment of FIG. 8 incorporates digital compensation logic that performs pixel-level lateral shifts, disparity correction, or geometric remapping of one or both image streams. These digital corrections mitigate double-vision effects that could otherwise occur when transitioning between pairs and ensure stable stereoscopic fusion throughout the entire magnification sequence.

By integrating mechanical alignment features with digital alignment correction, the system provides continuous stereoscopic imaging across all magnification ranges without requiring manual lens positioning or motor-based adjustments. This hybrid alignment approach eliminates the risk of “digital amblyopia,” where improperly aligned image streams could cause double vision for the user.

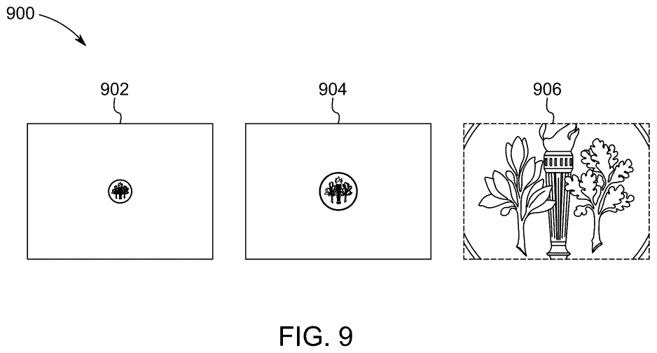

FIG. 9 illustrates an example stereoscopic image 900 captured using a CMOS/lens configuration suitable for inclusion within the multi-camera stereoscopic scopehead described herein. The image shown in FIG. 9 reflects the performance of a fixed-lens camera system equipped with high-resolution CMOS sensors, which may range from 4 megapixels to 20 megapixels or higher, depending on the embodiment.

In certain embodiments, each fixed-lens camera incorporates a CMOS sensor capable of delivering high-resolution image data at frame rates suitable for real-time surgical visualization. The sensors may support resolutions of 1920×1080 pixels per eye or greater, with pixel sizes sufficiently small to fall below the human minimum separable acuity threshold under typical viewing conditions. As a result, the stereoscopic display, when projected through OLED micro-projectors or similar devices, presents imagery in which the user cannot discern the individual pixels. In one example, 902, 904, 906 represent the growing, detailed imagery delivered by the CMOS sensor.

The embodiment represented by FIG. 9 is configured to achieve digital magnification by cropping a central region of the CMOS sensor output and scaling the cropped region to the output display resolution. This technique enables magnification levels from approximately 2× to 20× (or greater, depending on sensor resolution and lens selection) without any mechanical lens movement. When implemented across multiple fixed-lens camera pairs of differing focal lengths, the system transitions between pairs as needed to maintain optimal stereoscopic clarity and field of view throughout the magnification range.

In operation, small adjustments in the working distance—such as changes of less than approximately 10 millimeters—may be sufficient to maintain focus across the full zoom range for each camera pair. The combination of high-resolution CMOS sensors, fixed-lens optics, and digital crop-and-scale magnification provides stereoscopic imagery comparable to or superior to that of conventional motorized-zoom surgical microscopes but without the fragility and mechanical complexity associated with gear-driven zoom assemblies.

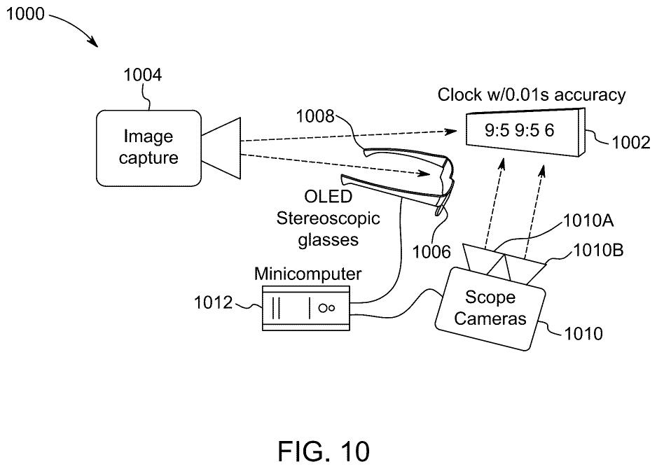

FIG. 10 illustrates an exemplary latency-measurement setup 1000 suitable for evaluating the glass-to-glass latency of the stereoscopic digital surgical visualization system, according to an embodiment of the present disclosure. In the embodiment shown, a reference clock 1002 is positioned within the field of view of the stereoscopic camera system such that the cameras concurrently capture the live image of the clock. An image-capture camera 1004 is positioned to simultaneously record both the reference clock 1002 and the OLED display image 1006 generated by the smartglasses 1008 or other stereoscopic display device, using the above-described main scope camera 1010 having a camera pair 1010A, 1010B. By capturing the direct clock reading and the corresponding displayed clock reading within the same video frame, the system enables measurement of the glass-to-glass latency, defined herein as the time difference between the occurrence of visual motion in the scene viewed by the CMOS sensors and its presentation on the output display. The processing unit 1012 may analyze the timestamp discrepancies between the reference clock 1002 and its displayed image to determine latency values with sub-frame precision.

In certain embodiments, the system is configured to maintain a glass-to-glass latency below perceptible thresholds during stereoscopic visualization, such that the movements observed through the display correspond closely to physical hand motions during surgical procedures. Latency values below approximately 300 milliseconds may be suitable for general manual tasks, while surgical visualization may benefit from latency values below approximately 133 milliseconds. In some embodiments, the system may be further optimized to achieve latency values below approximately 100 milliseconds to ensure visually seamless operation and minimize user fatigue or disorientation during prolonged stereoscopic viewing.

In some embodiments, the latency-measurement framework of FIG. 10 is used in conjunction with stereoscopic alignment procedures during system configuration. When the system transitions from 2D operation to stereoscopic 3D operation, each fixed-lens camera pair may be configured with appropriate toe-in angles, inter-axial distances, and field-of-view geometries to achieve accurate stereovision. The processing unit may employ real-time responsiveness to maintain stereoscopic convergence, depth fidelity, and viewer comfort. During stereoscopic operation, the system may be configured to avoid or compensate for potential stereovision artifacts, including window violations, depth-plane inconsistencies, or double-vision effects, by applying digital disparity correction or pixel-level alignment techniques. The latency-measurement approach shown in FIG. 10 ensures that the stereoscopic visualization presented to the user remains temporally synchronized, visually stable, and suitable for surgical applications requiring precise depth perception and real-time responsiveness.

In various embodiments of the stereoscopic digital surgical visualization system described herein, the processing unit may include additional software modules configured to enhance stereoscopic accuracy, prevent visual artifacts, and provide advanced surgical guidance and communication capabilities.

In some embodiments, the processing unit comprises software configured to perform digital shifting of one or both stereoscopic image frames to maintain or restore binocular alignment. The digital shifting may be applied before projection of the stereoscopic imagery to the smartglasses display, during active projection in real time, continuously, based on sensor input, or intermittently, in response to detected misalignment.

The digital shift may include one or more of the following operations: lateral pixel-shift adjustments between the left-and right-eye images, vertical pixel-alignment corrections, angular or rotational compensation of the stereoscopic frames, and depth-plane stabilization to maintain accurate stereoscopic convergence.

This functionality may be used to correct minor misalignment caused by transport or impact, deviations between camera pairs during magnification transitions, user-specific visual disparities, or other conditions that may result in stereoscopic double vision. In certain embodiments, the processing unit applies these corrections without interrupting the real-time stereoscopic video stream delivered to the smartglasses.

In some embodiments, the processing unit is further configured to integrate augmented-reality (AR) overlays into the stereoscopic imagery. The AR overlays may be displayed directly on the smartglasses, through binocular OLED projection, or in conjunction with an external 3D display system.

The augmented-reality overlays may include, but are not limited to, anatomical boundary markers, incision guides or trajectory indicators, tissue-depth estimates, crosshairs, scale bars, grid lines, orientation markers, instrument-tip tracking indicators, warnings or alerts related to distance, depth, or tool proximity, and AI-generated annotations or suggestions. The AR content may be dynamically adjusted based on camera-pair selection, real-time magnification level, working-distance sensor feedback, instrument position, or surgeon commands entered via the user interface. In some embodiments, the overlays are integrated into both the left-eye and right-eye image channels, such that the AR elements appear stereoscopically anchored within the surgical field.

In various embodiments, the processing unit is configured to record the stereoscopic imagery while the system is in operation. The recorded output may include the raw left-eye and right-eye video streams, digitally magnified stereoscopic sequences, alignment information applied during magnification transitions, augmented-reality overlays (if enabled), and system metadata such as timestamps, magnification level, or camera-pair selection.

The simultaneous ability to record and stream stereoscopic imagery enables real-time consultation, remote assistance, training, documentation, and post-procedure review.

In one embodiment, a digital zoom surgical visualization apparatus is provided, as illustrated conceptually in FIG. 6. The apparatus includes a plurality of stereoscopic camera pairs, each camera pair comprising two fixed-lens cameras configured to provide left-eye and right-eye image capture at a corresponding focal length. In the illustrated embodiment, each camera pair includes fixed optical lenses having differing focal lengths so that the plurality of camera pairs collectively span a wide magnification range suitable for surgical visualization. Each lens is coupled to a corresponding CMOS image sensor, which captures left-eye and right-eye image data, respectively, to generate stereoscopic image information.

The fixed-lens camera pairs may include, by way of non-limiting example, a wide-field stereoscopic pair for low magnification, an intermediate pair for medium magnification, and a high-magnification pair for microsurgical detail. Each camera pair operates without mechanical zoom mechanisms, thereby enhancing durability and resistance to mechanical shock, vibration, and lens misalignment.

The apparatus further includes a processor configured to receive image data from at least one of the stereoscopic camera pairs. The processor may selectively activate a particular camera pair based on a user-selected magnification request or automatically, depending on the system configuration. Upon receiving the image data, the processor is configured to perform digital crop-and-scale magnification, in which the central region of each left-eye and right-eye image is cropped and then scaled to generate a digitally magnified stereoscopic image pair. By applying digital magnification to the native high-resolution outputs of the CMOS sensors, the processor enables the apparatus to produce a continuous magnification range without requiring any mechanical lens movement.

In some embodiments, the processor may implement digital interpolation, pixel-shift adjustments, or geometric correction algorithms to ensure stereoscopic alignment between the left-eye and right-eye imagery during magnification changes. The processor may also buffer the stereoscopic image streams, apply color correction or illumination compensation, and prepare the imagery for presentation on downstream display modules.

The digitally magnified stereoscopic imagery is transmitted to a smartglasses display, which includes left-eye and right-eye micro-projection elements or OLED micro-projectors configured to present stereoscopic imagery directly to the user. The smartglasses display provides an immersive, real-time stereoscopic view of the surgical field, enabling the user to visualize tissue structures and instruments with depth perception similar to that of a conventional surgical microscope but without the physical constraints of ocular tubes or large display monitors.

The smartglasses display may be lightweight, head-mounted, and ergonomically designed to allow prolonged usage without strain. In some embodiments, the smartglasses may communicate with the processor via a wired connection, a detachable cable, or a wireless low-latency link. The combination of the fixed-lens stereoscopic camera pairs, digital crop-and-scale magnification, and stereoscopic smartglasses display enables the apparatus to provide continuous zoom, stable stereoscopic depth cues, and high-resolution surgical visualization in a compact, and mechanically simplified form factor suitable for both pristine and austere medical environments.

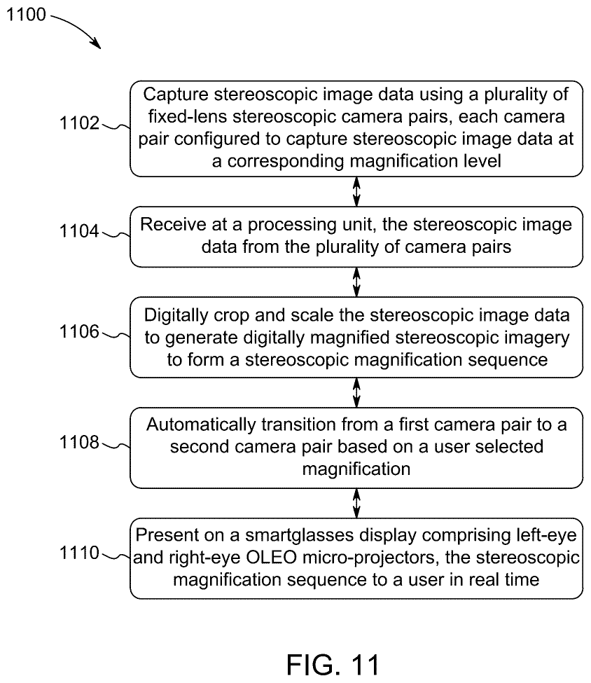

FIG. 11 illustrates an exemplary method 1100 for performing stereoscopic digital surgical visualization using multiple fixed-lens stereoscopic camera pairs, according to an embodiment of the present disclosure. The method may be executed by any surgical visualization apparatus described herein, including systems incorporating a plurality of fixed-lens stereoscopic camera pairs, a processing unit, and a stereoscopic smartglasses display.

Although FIG. 11 is described as a sequence of steps, it will be understood that the method may be implemented in various orders, in parallel, with additional steps, or with optional sub-steps, and that no particular sequence is required unless explicitly stated.

At step 1102, stereoscopic image data is captured using a plurality of fixed-lens stereoscopic camera pairs. Each camera pair includes two fixed-lens cameras arranged to provide left-eye and right-eye viewpoints and may be configured with a unique focal length corresponding to a particular optical magnification level.

At step 1104, the stereoscopic image data captured by the plurality of camera pairs is received by a processing unit. The processing unit may selectively activate specific camera pairs, retrieve captured image data from one or more active camera pairs, buffer incoming left-eye and right-eye image streams, and prepare image data for digital magnification and display.

The processing unit may continuously receive data from all camera pairs or selectively access camera pairs based on user commands or automated control logic.

At step 1106, the processing unit digitally crops and scales the stereoscopic image data to generate digitally magnified stereoscopic imagery. This may include identifying a central region of interest in the left-eye and right-eye images, reducing (cropping) peripheral pixel regions, scaling the cropped region to match the output resolution of the display device, and preserving inter-eye disparity to maintain stereoscopic depth perception.

The crop-and-scale operation allows the system to achieve continuous digital magnification without any physical lens movement.

At step 1108, the processing unit automatically transitions from a first camera pair to a second camera pair based on the user-selected magnification. The transition may occur when the user selects a magnification that corresponds to a different optical range, or when system logic determines that a different camera pair will provide improved resolution or field of view. This ensures seamless visual continuity in the stereoscopic magnification sequence.

At step 1110, the digitally magnified stereoscopic imagery is presented to the user through a smartglasses display. In some embodiments, the smartglasses include a left-eye OLED micro-projector, and a right-eye OLED micro-projector.

The smartglasses receive the stereoscopic magnification sequence from the processing unit and display the left-eye and right-eye imagery in real time, providing depth perception and a magnified surgical view suitable for microsurgical tasks.

### EMBODIMENTS

1. A stereoscopic digital surgical microscope system, comprising:
a scope head comprising a plurality of fixed-lens stereoscopic camera pairs, each camera pair configured to capture stereoscopic image data at a corresponding magnification level;
a processing unit configured to receive the stereoscopic image data from the plurality of camera pairs, digitally crop and scale the image data to generate digitally magnified stereoscopic imagery, and automatically transition between the camera pairs based on a user-selected magnification, wherein the processing unit controls the selection of the camera pairs to generate a stereoscopic magnification sequence; and
a smartglasses display comprising left-eye and right-eye OLED micro-projectors configured to present the stereoscopic magnification sequence to a user in real time.

2. The system of Embodiment 1, wherein a stereoscopic video stream is generated by merging the digitally magnified stereoscopic imagery, wherein the system is free of motor-and-gear driven zoom mechanisms.

3. The system of Embodiment 2, wherein the stereoscopic video stream is configured for delivery directly to the smartglasses display.

4. The system of Embodiment 2, wherein the processing unit is configured to record the stereoscopic video stream while simultaneously transmitting the stereoscopic video stream to the smartglasses display in real time.

5. The system of Embodiment 2, wherein the stereoscopic video stream includes alignment information generated during each magnification transition to maintain depth fidelity.

6. The system of Embodiment 1, wherein the processing unit further comprises software configured to digitally shift at least one stereoscopic image frame before or during projection to the smartglasses display, to compensate for misalignment or to avoid stereoscopic double vision.

7. The system of Embodiment 1, wherein the scope head is configured to withstand an impact drop from approximately 36 inches onto a rigid surface in multiple orientations without loss of stereoscopic functionality.

8. The system of Embodiment 1, further comprising an integrated illumination module comprising one or more LED arrays arranged around the plurality of camera pairs.

9. The system of Embodiment 1, further comprising a rechargeable battery system configured to power the scope head, and the processing unit.

10. The system of Embodiment 1, wherein the processing unit is further
configured to overlay augmented-reality surgical guidance information within the stereoscopic imagery.

11. The system of Embodiment 1, wherein the processing unit is configured to record the stereoscopic imagery and stream the imagery in real time to external computing devices.

12. The system of Embodiment 1, wherein each fixed-lens camera comprises a CMOS sensor having a resolution of at least 20 megapixels and is part of a stereoscopic camera pair configured for surgical magnification.

13. A digital zoom surgical visualization apparatus, comprising:
a plurality of stereoscopic camera pairs, each camera pair comprising fixed lenses having differing focal lengths and dual CMOS sensors configured to capture left-eye and right-eye image data;
a processor configured to receive image data from at least one of the stereoscopic camera pairs and to digitally crop and scale the image data to generate digitally magnified stereoscopic imagery across a continuous magnification range; and
a smartglasses display configured to present the digitally cropped and scaled left-eye and right-eye imagery to a user.

14. A method for stereoscopic digital surgical visualization, comprising:
capturing stereoscopic image data using a plurality of fixed-lens stereoscopic camera pairs, each camera pair configured to capture stereoscopic image data at a corresponding magnification level;
receiving, at a processing unit, the stereoscopic image data from the plurality of camera pairs;
digitally cropping and scaling the stereoscopic image data to generate digitally magnified stereoscopic imagery to form a stereoscopic magnification sequence;
automatically transitioning from a first camera pair to a second camera pair based on a user selected magnification;
presenting, on a smartglasses display comprising left-eye and right-eye OLED micro-projectors, the stereoscopic magnification sequence to a user in real time.

15. The method of Embodiment 14, further comprising merging the digitally magnified stereoscopic imagery to form a stereoscopic video stream.

16. The method of Embodiment 14, further comprising generating alignment information during each transition between the camera pairs to maintain stereoscopic depth fidelity.

17. The method of Embodiment 14, further comprising digitally shifting at least one stereoscopic image frame laterally to compensate for misalignment or to avoid stereoscopic double vision.

18. The method of Embodiment 14, further comprising illuminating a surgical field using an integrated illumination module comprising one or more LED arrays arranged around the plurality of camera pairs.

19. The method of Embodiment 14, further comprising overlaying augmented-reality surgical guidance information within the digitally magnified stereoscopic imagery.

20. The method of Embodiment 14, further comprising recording the digitally magnified stereoscopic imagery and streaming the imagery in real time to one or more external computing devices.

Although some of the figures described in the foregoing specification include flow diagrams with steps that are shown in an order, the steps may be performed in any order, and are not limited to the order shown in those flowcharts. Additionally, some steps may be optional, performed multiple times, and/or handled by different components. All steps, operations, and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan, or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms, and their implementation.

In the foregoing specification, the example embodiment(s) of the present disclosure have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A stereoscopic digital surgical microscope system, comprising:
a scope head comprising a plurality of fixed-lens stereoscopic camera pairs, each camera pair configured to capture stereoscopic image data at a corresponding magnification level;
a processing unit configured to receive the stereoscopic image data from the plurality of camera pairs, digitally crop and scale the image data to generate digitally magnified stereoscopic imagery, and automatically transition between the camera pairs based on a user-selected magnification, wherein the processing unit controls the selection of the camera pairs to generate a stereoscopic magnification sequence; and
a smartglasses display comprising left-eye and right-eye OLED micro-projectors configured to present the stereoscopic magnification sequence to a user in real time.

2. The system of claim 1, wherein a stereoscopic video stream is generated by merging the digitally magnified stereoscopic imagery, wherein the system is free of motor-and-gear driven zoom mechanisms.

3. The system of claim 2, wherein the stereoscopic video stream is configured for delivery directly to the smartglasses display.

4. The system of claim 2, wherein the processing unit is configured to record the stereoscopic video stream while simultaneously transmitting the stereoscopic video stream to the smartglasses display in real time.

5. The system of claim 2, wherein the stereoscopic video stream includes alignment information generated during each magnification transition to maintain depth fidelity.

6. The system of claim 1, wherein the processing unit further comprises software configured to digitally shift at least one stereoscopic image frame before or during projection to the smartglasses display, to compensate for misalignment or to avoid stereoscopic double vision.

7. The system of claim 1, wherein the scope head is configured to withstand an impact drop from approximately 36 inches onto a rigid surface in multiple orientations without loss of stereoscopic functionality.

8. The system of claim 1, further comprising an integrated illumination module comprising one or more LED arrays arranged around the plurality of camera pairs.

9. The system of claim 1, further comprising a rechargeable battery system configured to power the scope head, and the processing unit.

10. The system of claim 1, wherein the processing unit is further configured to overlay augmented-reality surgical guidance information within the stereoscopic imagery.

11. The system of claim 1, wherein the processing unit is configured to record the stereoscopic imagery and stream the imagery in real time to external computing devices.

12. The system of claim 1, wherein each fixed-lens camera comprises a CMOS sensor having a resolution of at least 20 megapixels and is part of a stereoscopic camera pair configured for surgical magnification.

13. A digital zoom surgical visualization apparatus, comprising:
a plurality of stereoscopic camera pairs, each camera pair comprising fixed lenses having differing focal lengths and dual CMOS sensors configured to capture left-eye and right-eye image data;
a processor configured to receive image data from at least one of the stereoscopic camera pairs and to digitally crop and scale the image data to generate digitally magnified stereoscopic imagery across a continuous magnification range; and
a smartglasses display configured to present the digitally cropped and scaled left-eye and right-eye imagery to a user.

14. A method for stereoscopic digital surgical visualization, comprising:
capturing stereoscopic image data using a plurality of fixed-lens stereoscopic camera pairs, each camera pair configured to capture stereoscopic image data at a corresponding magnification level;
receiving, at a processing unit, the stereoscopic image data from the plurality of camera pairs;
digitally cropping and scaling the stereoscopic image data to generate digitally magnified stereoscopic imagery to form a stereoscopic magnification sequence;
automatically transitioning from a first camera pair to a second camera pair based on a user selected magnification;
presenting, on a smartglasses display comprising left-eye and right-eye OLED micro-projectors, the stereoscopic magnification sequence to a user in real time.

15. The method of claim 14, further comprising merging the digitally magnified stereoscopic imagery to form a stereoscopic video stream.

16. The method of claim 14, further comprising generating alignment information during each transition between the camera pairs to maintain stereoscopic depth fidelity.

17. The method of claim 14, further comprising digitally shifting at least one stereoscopic image frame laterally to compensate for misalignment or to avoid stereoscopic double vision.

18. The method of claim 14, further comprising illuminating a surgical field using an integrated illumination module comprising one or more LED arrays arranged around the plurality of camera pairs.

19. The method of claim 14, further comprising overlaying augmented-reality surgical guidance information within the digitally magnified stereoscopic imagery.

20. The method of claim 14, further comprising recording the digitally magnified stereoscopic imagery and streaming the imagery in real time to one or more external computing devices.
